(19) United States
(12) Patent Application Publication
(10) Pub. No.: US 2015/0051978 A1
(43) Pub. Date: Feb. 19, 2015

(54) SYSTEM AND METHOD FOR OPTIMIZING PROMOTION OF A SOCIAL EVENT IN A NETWORK ENVIRONMENT

(71) Applicant: MATCH.COM, L.L.C., Dallas, TX (US)

(72) Inventors: Thomas Edward Jacques, Long Island City, NY (US); Michael George Maxim, Bronx, NY (US); Tom R. Quisel, New York, NY (US)

(73) Assignee: MATCH.COM, L.L.C., Dallas, TX (US)

(21) Appl. No.: 13/967,983

(22) Filed: Aug. 15, 2013

(51) Int. Cl. G06Q 30/02; G06F 17/30; G06Q 50/00

(52) U.S. Cl. CPC G06Q 30/0269; G06Q 50/01; G06F 17/30702
USPC 705/14.66

(57) ABSTRACT

A method is provided in one example embodiment and includes determining a score for at least one parameter associated with an event and a user and applying to the score a filter associated with the at least one parameter to determine whether the score falls within a range defined by the filter. The method also includes displaying the event to the user if the score falls within the range defined by the filter and hiding the event from the user if the score falls outside of the range defined by the filter.

### TECHNICAL FIELD

This disclosure relates in general to the field of communications and, more particularly, to a system and a method for optimizing promotion of a social event in a network environment.

### BACKGROUND

Communications network architectures have experienced significant notoriety because they can offer the benefits of automation, convenience, and data management for their respective online communities. Certain network protocols may be used in order to allow an end user to be matched to other end users or to scenarios in which they stand to benefit (e.g., job searches, person-finding services, real estate searches, online dating, etc.).

In the case of an online dating service, for example, an end user will typically be prompted to specify a variety of preferences to be used in matching the end user with other end users in a particular online dating community. The information each end user provides about him or herself may be viewed by other end users in the online community in determining whether to interact with that end user. In certain cases, the actual dating platform can participate in matching activities. This interventionist involvement and often spur or provoke new relationships being formed.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a network diagram showing an operating environment of the present disclosure in accordance with one embodiment of the present disclosure;

FIGS. 2A-J are simplified screen shots of an example protocol for participating in an on-line dating service in accordance with one embodiment of the present disclosure;

FIGS. 3-5 are flow diagrams illustrating logic implemented by an event promotion feature of an on-line dating service, such as illustrated in FIGS. 1-2J, in accordance with one embodiment of the present disclosure.

### DETAILED DESCRIPTION OF EXAMPLE EMBODIMENTS

### Overview

A method is provided in one example embodiment and includes determining a score for identifying for at least one parameter associated with an event and a user. The ‘score’ can include any type of resultant such as a numeric result, a grade, an internal code or label, where any such resultants can be developed through an algorithm, an administrator, etc. The ‘event’ can include any type of social gathering between two individuals, or a group of individuals (e.g., a cooking class, a movie showing, a sports event, a concert, a day at a public park, a museum outing, a coffee date, a festival, a dance, a dinner date, a political debate, etc.). The method can also include applying to the score a filter associated with the at least one parameter to determine whether the score falls within a range defined by the filter. The method also includes displaying the event to the user if the score falls within the range defined by the filter and hiding the event from the user if the score falls outside of the range defined by the filter. The determining a score may include assigning an initial value to the score; incrementing the score for each participant in the event with whom the user is a potential match based on a first set of criteria; and decrementing the score for each participant in the event with whom user is not a potential match based on the first set of criteria. In some embodiments, the displaying comprises presenting information regarding the event on a web page accessible by the user and the information may include an invitation to participate in the event.

In certain embodiments, the at least one parameter comprises one of a targeted age for participants in the event, a targeted gender/orientation for participants in the event, a geographic location, and a match quality quantifying how closely matched the user is with participants in the event. The at least one parameter may comprise a plurality of parameters and each of the parameters has associated therewith a filter defining a range and the method may include, for each of the parameters, determining a score for the parameter; and applying to the score the filter associated with the parameter to determine whether the score falls within the range defined by the filter and thereby passes application of the filter.

In at least one embodiment, the method further includes displaying the event to the user if all of the scores pass application of the respective filters and hiding the event from the user if one of the scores fails to pass application of the respective filter. The method may further include computing a weighted average of the parameter scores and applying a filter to the weighted average of the parameter scores.

### Example Embodiments

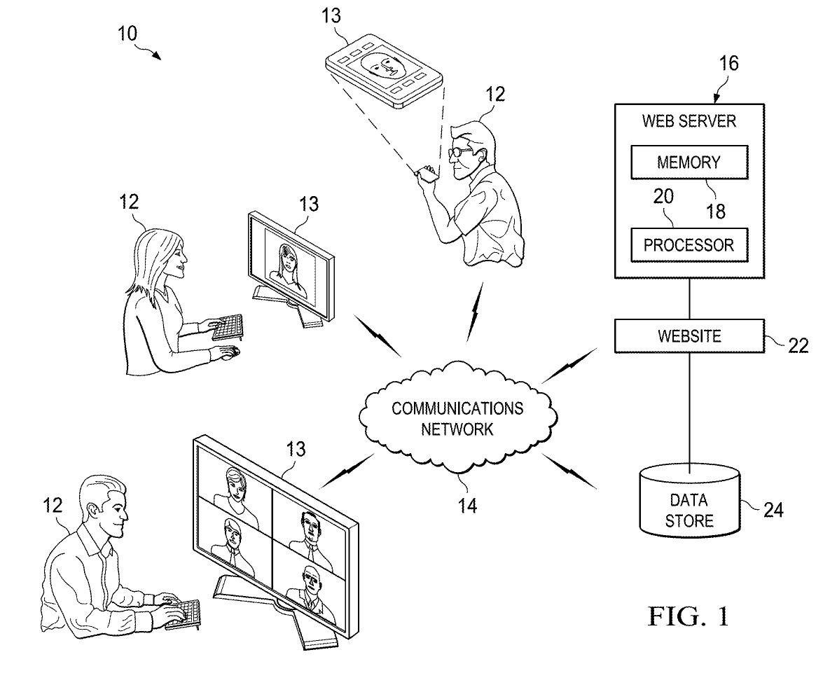

FIG. 1 is a simplified block diagram of a system 10 for facilitating an online dating scenario in a network environment. In other embodiments in which communications or matching is valuable, system 10 can be leveraged to identify and to evaluate suitable candidates in other areas (e.g., hiring/employment, recruiting, real estate, general person searches, etc.). FIG. 1 includes multiple end users 12 and endpoints 13, a communications network 14, a web server 16 comprising memory 18 and a at least one processor 20, a website 22, and a data store 24. Data store 24 may be any type of mechanism for storing data, including but not limited to one or more files, databases, memory devices, mass storage devices, data centers, etc. System 10, users 12 interact with web server 16 via endpoints 13, each of which comprises an appropriate user interface for interacting with web server 16 via website 22 for facilitating functions and features described herein. In certain example implementations, website 22 and web server 16 are consolidated into a single component, physical structure, equipment, etc.

FIG. 1 may be configured such that inter- and intra-communications are readily achieved by any of the components included therein. The present disclosure is capable of providing both an online component (as illustrated in FIG. 1) and an off-line component such that one or more end users can meet, gather information, resolve to meet, and then subsequently meet in person with the assistance of system 10. Ancillary components to such a comprehensive process may involve pre-date profiles, post-date follow-ups, and a myriad of other significant features, some of which are outlined in greater detail below.

End users 12 may include a variety of types of end users, such as clients, customers, prospective customers, or entities wishing to participate in an online dating scenario and/or to view information associated with other participants in the system. End users 12 may also seek to access or to initiate communications with other end users that may be delivered via communications network 14. End users 12 may review data (such as user profiles, for example) associated with other users in order to make matching decisions or selections. Data, as used herein in this document, refers to any type of numeric, voice, video, or script data, or any other suitable information in any appropriate format that may be communicated from one point to another.

End users 12 may access the aforementioned data via endpoints 13, which may be inclusive of devices used to initiate a communication. Note that the broad term “user” encompasses any type of node or user device, or any type of endpoint discussed herein. Additionally, the term “user” can further include any type of profile to be used in the system discussed herein. Hence, the term “user” can include (but is not limited to) elements such as a computer, a personal digital assistant (PDA), a laptop or electronic notebook, a cellular telephone, an IP telephone, an iPhone™, an iPad™, a Microsoft Surface™, an Android™ phone, a Google Nexus™, or any other device, component, element, or object capable of initiating voice, audio, or data exchanges within communication system 10. The endpoints may be inclusive of a suitable interface to the end user 12, such as a microphone, a display, or a keyboard or other terminal equipment. Endpoints 13 may also include any device that seeks to initiate a communication on behalf of another entity or element, such as a program, a database, or any other component, device, element, or object capable of initiating a voice or a data exchange within communication system 10. In addition, each of the endpoints 13 may be a unique element designed specifically for communications involving system 10. Such an element may be fabricated or produced specifically for matching applications involving end user 12 and endpoint 13.

A user may employ any device capable of operating as an endpoint 13 to connect to communications network 14 via wire, wireless, cellular, satellite link or other suitable interfaces. Web server 16, which as previously noted includes memory 18 and at least one processor 20, hosts website 22 and has access to transmit and receive user or presence data (e.g., user profile data, user and/or user endpoint data, user contact data) from database 24. Presence data may be collected, aggregated, and utilized as required to facilitate communications between endpoints 12 over communications network 10 or other outside communication systems. Presence data may also include information and/or instructions enabling the creation, duration, and termination of communication sessions between diverse endpoints 13 that utilize different communication and/or networking protocols.

Communications network 14 is a communicative platform operable to exchange data or information emanating from endpoints 13. Communications network 14 represents an Internet architecture in a particular embodiment of the present disclosure, which provides end users 12 with the ability to electronically execute or to initiate actions associated with finding a potential match candidate. Alternatively, communications network 14 could be a plain old telephone system (POTS), which end user 12 could use to perform the same operations or functions. Such transactions may be assisted by management associated with website 22 or manually keyed into a telephone or other suitable electronic equipment. In other embodiments, communications network 14 could be any packet data network (PDN) offering a communications interface or exchange between any two nodes in system 10. Communications network 14 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment.

In one embodiment, web server 16 comprises a server that is operable to receive and to communicate information to one or more end users 12. In a generic sense, web server 16 can implement a computer-implemented matching system that provides a framework for suitable matching activities. Alternatively, web server 16 may be any switch, router, gateway, cache, server blade, software, processor, proprietary component, object, module, or element (or any combination of these) operable to facilitate communications involving end user 12. Web server 16 may be integrated with database 24 and/or website 22, where any one or more of these elements may share or otherwise coordinate the activities discussed herein.

In one particular embodiment, web server 16, via interaction with database 24 and/or in conjunction with website 22, is engaged in facilitating interaction(s) between parties interested in seeking a romantic partner (i.e., online dating). For example, website 22 can be online dating service provider www.Match.com, www.Chemistry.com, or any other suitable provider. In certain example scenarios, a given end user may pay a fee for a subscription-based service (and potentially, only those users would qualify to be eligible to participate in events in certain example implementations, although other example embodiments involve non-members being eligible for participation). Additionally, certain end user fee structures may apply to different tiers of service: some of which may entitle an end user to enhanced features on website 22 (e.g., the ability to communicate more frequently with other users, additional matches being provided (potentially, more frequently) to an end user who paid the higher fee structure, the ability to store data, the ability to share data, the ability to upload additional information, the ability to target specific searches based on particular criteria, the ability to receive preferential positioning in the context of being matched to other users, the ability to perform video calls (e.g., Skype, etc.) with other users, the ability to perform audio calls with other users, etc.).

In certain embodiments, website 22 is a computer-implemented matching system, which may be any website or architecture provided for facilitating a connection involving two or more people, and which may make use of a given profile, photograph, resume, article description, etc. This could include services associated with job placements, escort services, auction services, social media, real estate listings, recruiting services (e.g., in athletics, academia, employment scenarios, instances involving the sales of goods and services), etc.

Considerable flexibility is provided by the structure of web server 16 and website 22 in the context of system 10. Thus, it can be easily appreciated that such functions could be provided external to web server 16 or website 22. In such cases, such a functionality could be readily embodied in a separate component, server, processor, device, or module. Note that these online dating features and capabilities may be provided in just one of these elements, in both, or distributed across both of them. Hence, in certain embodiments, the online dating operations may be consolidated in a single website, where no redirection is needed, nor performed for the user.

In operation of an example embodiment, consider a case where a given end user is interested in participating in an online dating scenario. End user 12 can access website 22 via the communications network 14 (which in the example presented comprises the Internet) using endpoint 13, register, and create a profile on the site. Moreover, end user 12 can access website 22 through any suitable banner, pop-up, partnership, e-mail solicitations, direct mailings, etc. It can be appreciated that online commerce can be generated by a plethora of marketing tools and any such tools can readily cooperate with the operations of the present disclosure.

At this point, matching of any form can commence amongst the members of the online community. For example, in the context of a romantic endeavor, a person may begin the dating process or engage in communications that would spawn such dating. Other applications could include job applicants who are being sought by employers. Any of the individuals who reside in the online community can begin using any of the tools or capabilities of the platform.

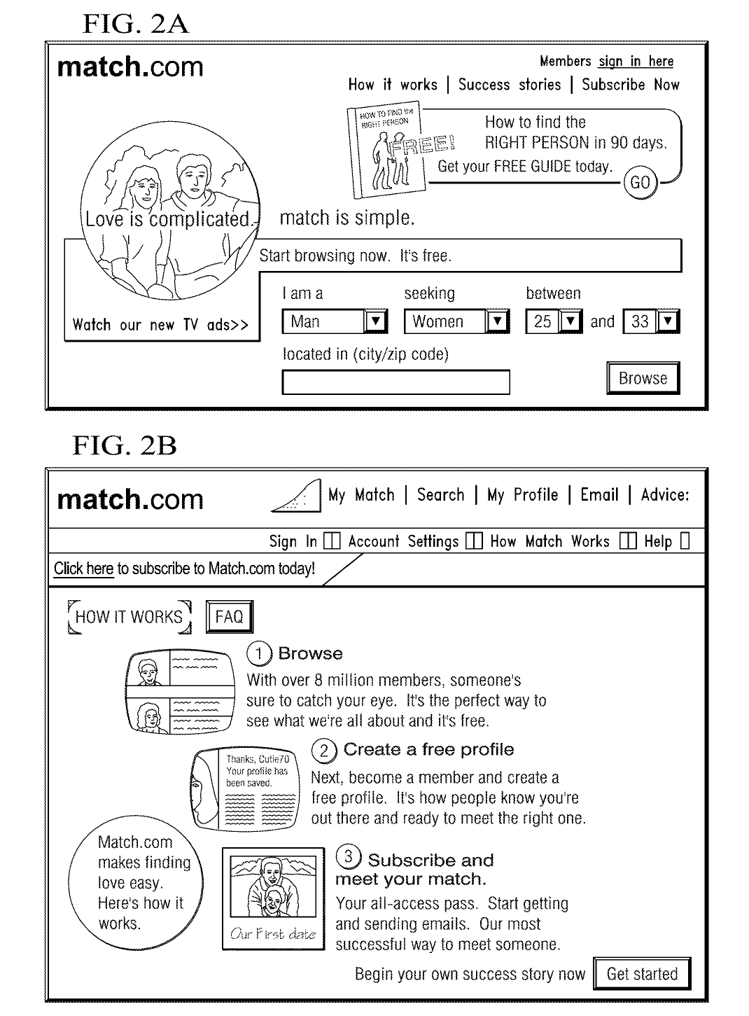

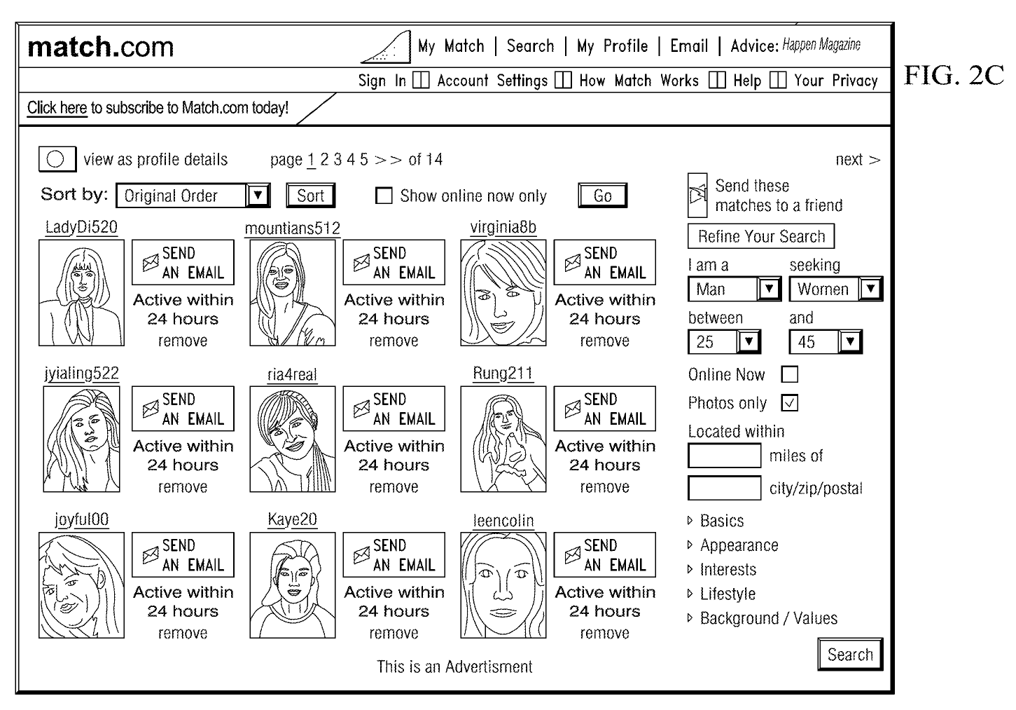

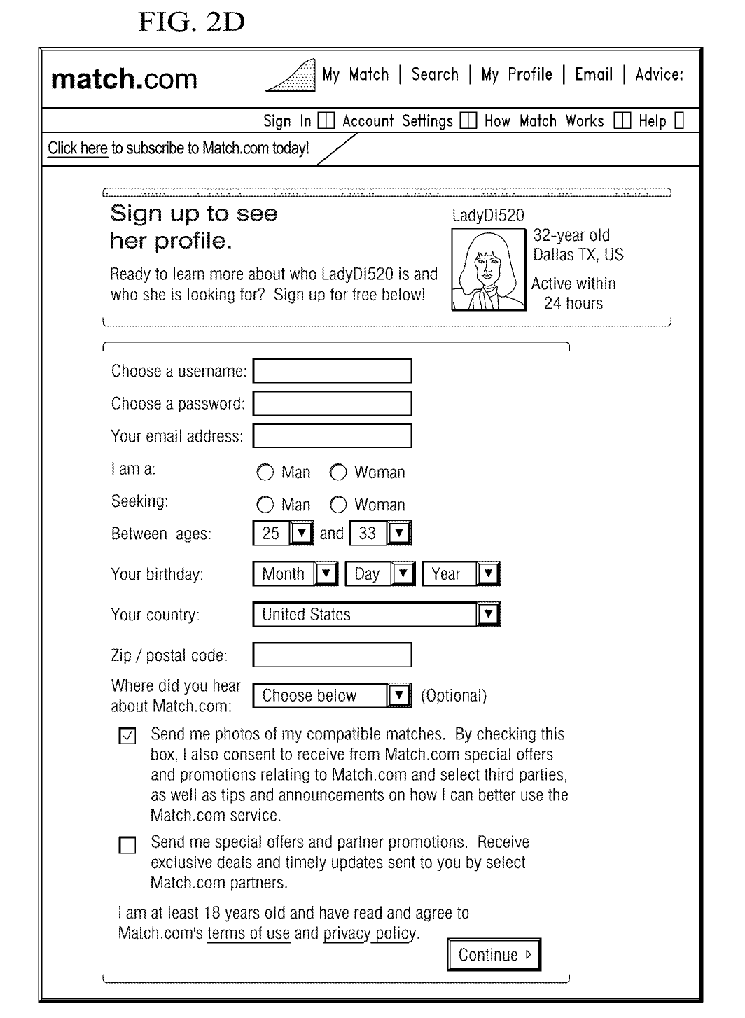

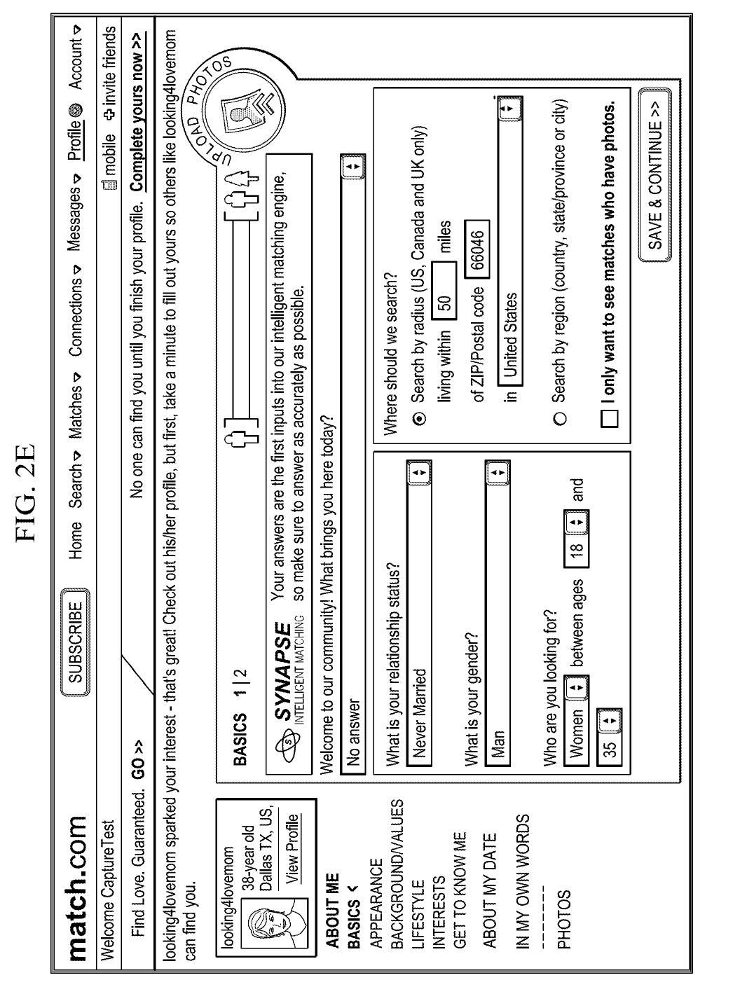

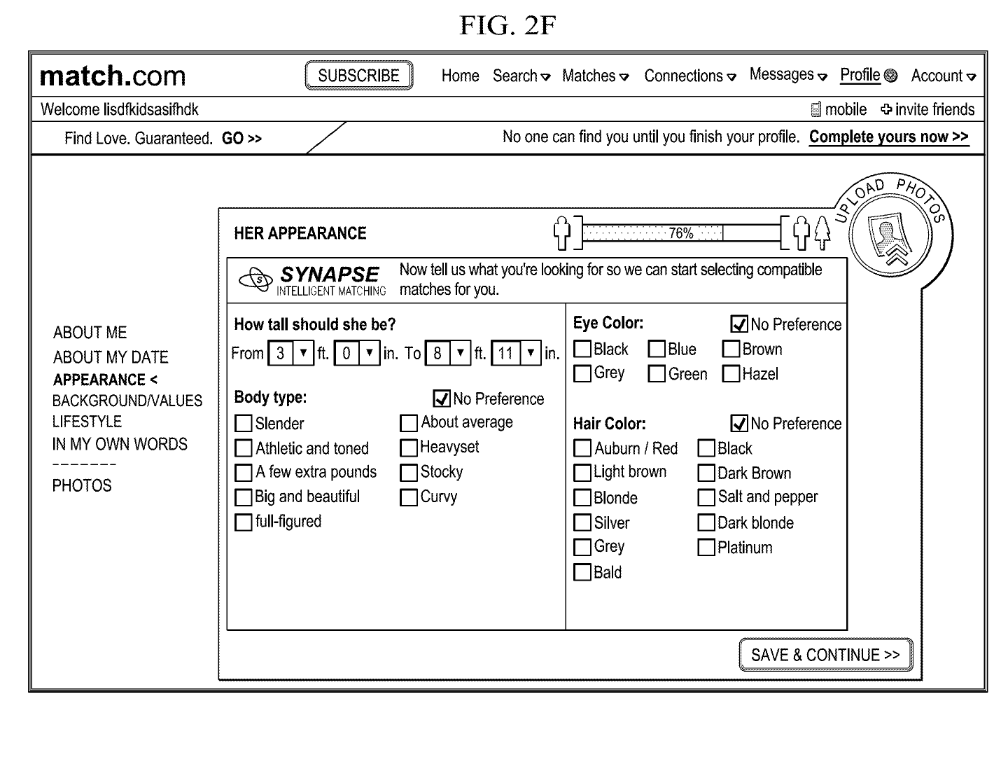

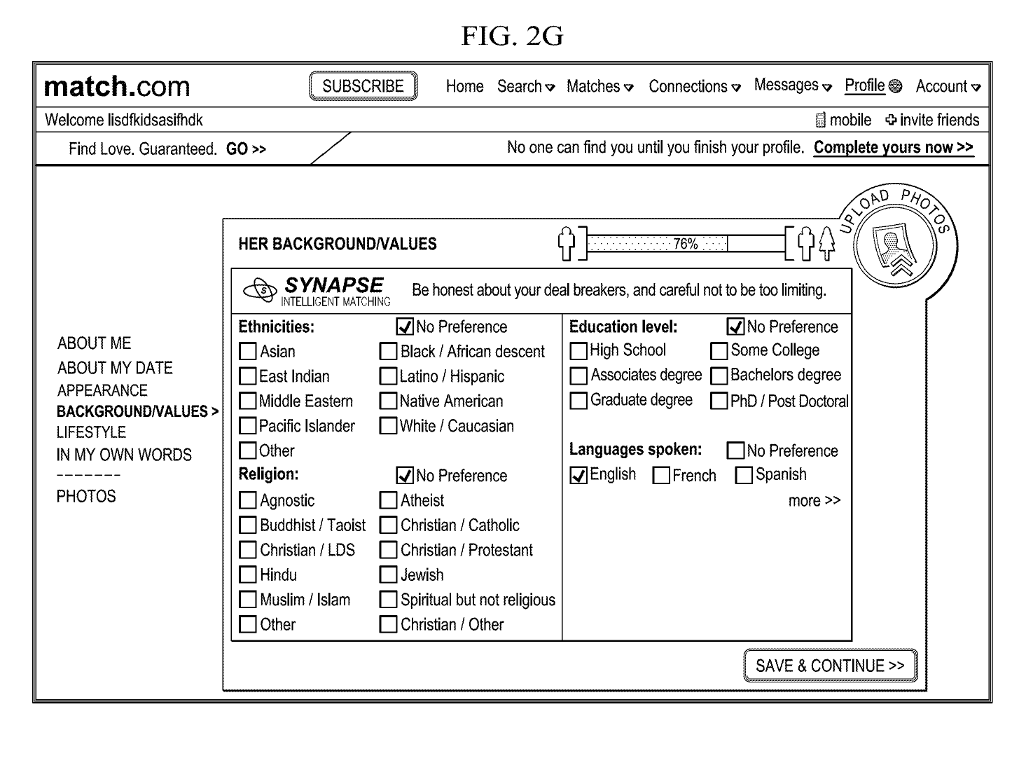

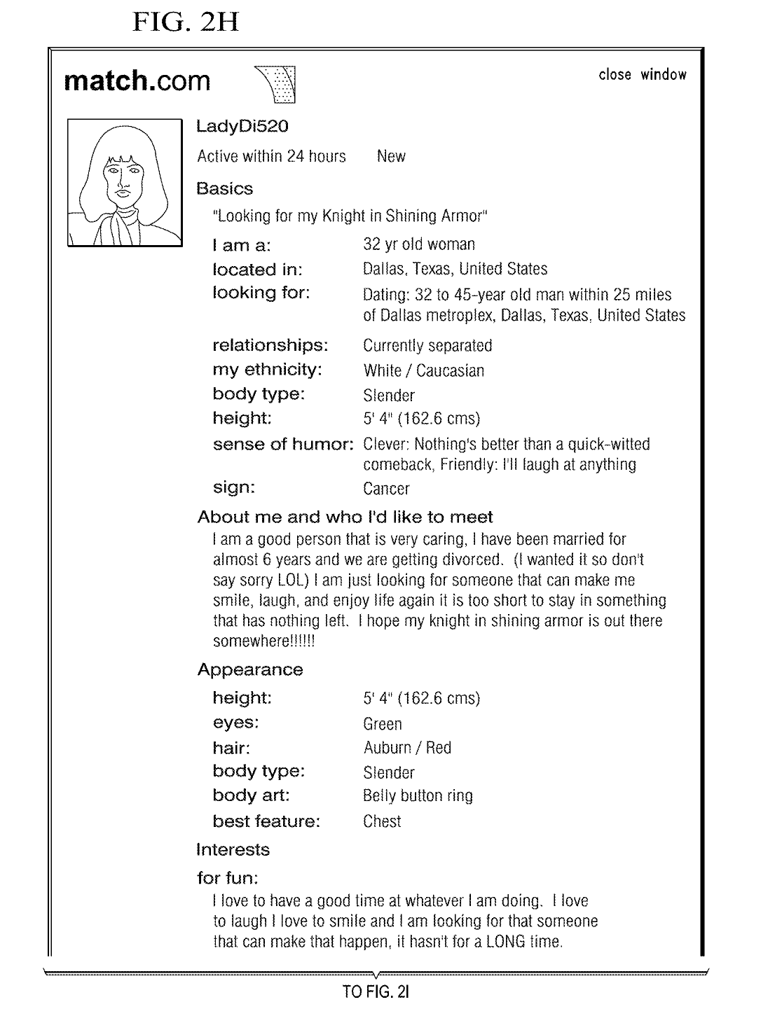

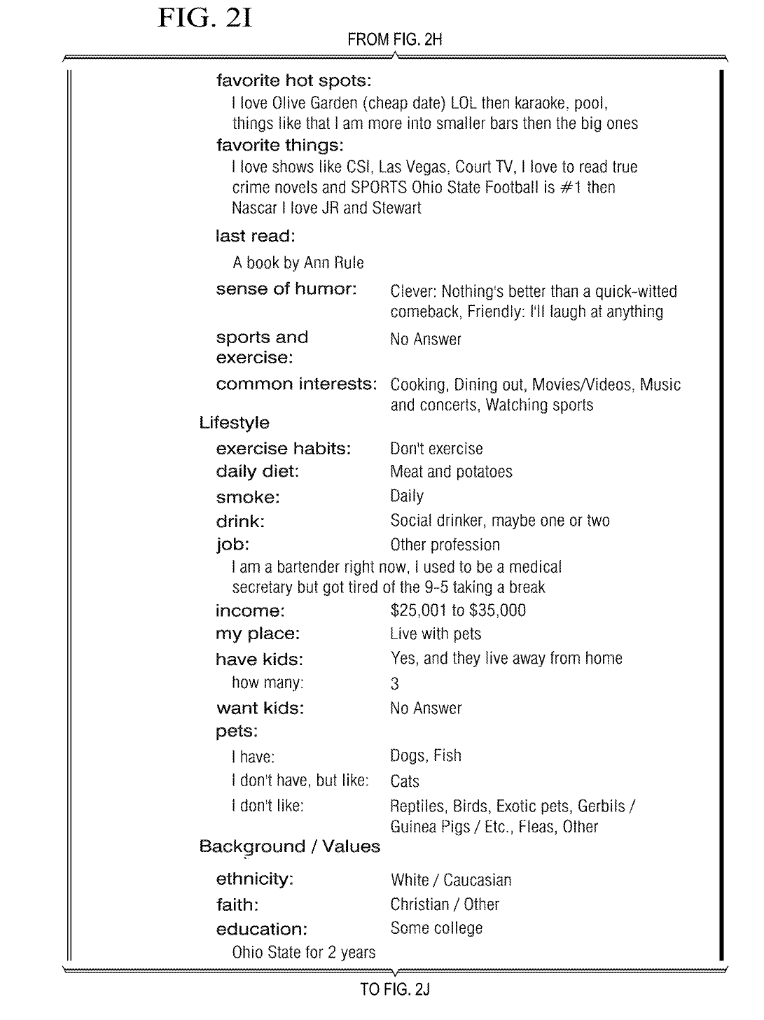

FIGS. 2A-2J illustrate example screen shots that may be provided in the online dating process to facilitate presentation of information to and gathering of information from member end users. FIGS. 2A-2J are presented herein for purposes of discussion. It is imperative to note that these illustrations are only being provided to further outline a particular implementation of the present disclosure. In no way should these diagrams be used to limit or to restrict the broad teachings of the present disclosure. Such illustrative information has been offered earnestly and, thus, should not be construed to confine the broad applications of the present disclosure.

FIG. 2A is an example screen shot of a home page from which an interested end user may begin his/her journey. In the illustrated example, the home page solicits location information, such as a city or zip code, as well as an indication of the end user's gender and an age range and gender preference of persons the end user is interested in “meeting” via system 10. Subsequent to the end user's completion of the requested information and clicking on a “How it Works” icon on the home page of FIG. 2A, a screen shot as shown in FIG. 2B is presented to the end user. The screen shot of FIG. 2B provides a generic outline of the online dating process. As outlined in the screen shot of FIG. 2B, as a first step, an end user may choose to browse the website to view pictures of members along with summaries of the members' profiles. After browsing the website, the end user may decide to create a free profile. Once the end user browses the website and creates a profile, the end user may opt to subscribe to the service and receive information from/about others who are part of the online community. For purposes of example and ease of explanation, it will be assumed for the remainder of the discussion of FIGS. 2A-2D that the potential new end user investigating and ultimately subscribing to the service is a male named “Tom” who is interested in finding a female match.

FIG. 2C is an example screen shot of a number of profiles that may be viewed by Tom during the browsing phase described above. In the context of this shot, Tom may be simply browsing. Assuming Tom has decided he would like to know more about one of the members whose profile is presented in FIG. 2C, he may click on the picture associated with the selected profile. For example, assuming Tom has decided he would like more information about “LadyDi520”, clicking on her picture results in his being directed to a web page as shown in FIG. 2D, where he is solicited to sign up for the online dating subscription such that he can effectively contact his candidate selection. It will be noted that the information solicited using the page shown in FIG. 2C may be used in selecting matches for Tom. The information may also be displayed on Tom's profile or summary thereof presented to other users to assist those users in determining whether they are interested in interacting with him.

FIGS. 2E-2G illustrate various screen shots comprising a user information collection process in accordance with one embodiment. Using the web pages illustrated in FIGS. 2E-2G, system 10 collects a variety of information from an end user, including, but not limited to, basic information about the end user (FIG. 2E), as well as information about the type person the end user would be interested in dating, including information about a potential date's physical appearance (FIG. 2F) and background and values (FIG. 2G). It will be recognized that the information collected using the web pages illustrated in FIGS. 2E-2G is illustrative only and that any type/amount of information may be solicited in the illustrated manner.

FIGS. 2H-2J are example screen shots of the full profile of LadyDi520, the picture Tom selected while browsing. In illustrated profile, LadyDi520's match criteria are displayed, as well as other information that may be pertinent to a potential mate. Any suitable items can be provided in such a profile (such as interests, favorite hot spots, favorite things, desire for children, background, etc.). Virtually any type or format of information (inclusive of video and audio data) may be provided in such a profile. In particular, the profile includes information that was solicited from LadyDi520 when she set up her online dating account. The profile may include a photo, biographical information (e.g., gender, age, location, relationship status, etc.), physical information (e.g., height, weight, hair and eye color, etc.), interests (e.g., hobbies, “favorites,” etc.), lifestyle information (e.g., exercise habits, employment, smoking/drinking habits, etc.), and background/values (e.g., ethnicity, faith, education, etc.). The profile may also include a section entitled “About My Date,” in which the end user specifies preferences about the type of person he/she would like to meet/date (e.g., appearance, interests, faith, education, relationship goals, etc.). In some embodiments, a full profile, including the profile information provided by the end user and stored in the system, is displayed to interested viewers; in other embodiments, only a summary or subset of the profile information is displayed.

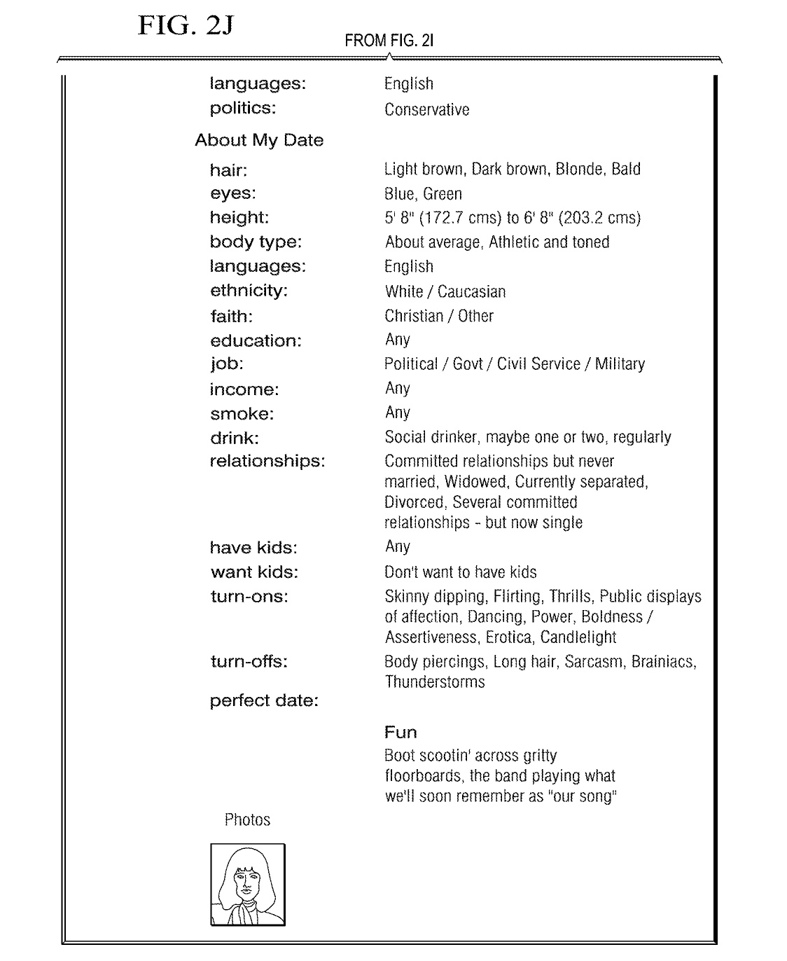

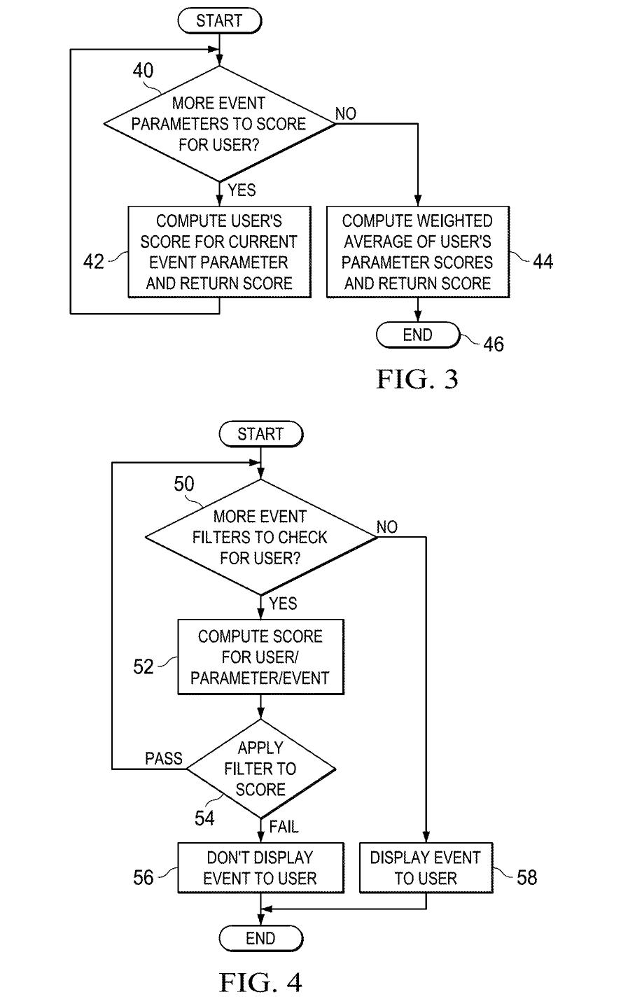

In one embodiment, the system 10 may include a feature referred to herein as an event promotion feature. As will be described in detail below with reference to FIGS. 3-5, one objective of the event promotion feature is to determine which users of the system 10 to whom an event should be promoted. In one embodiment, promotion of an event comprises presenting information about the event, including in some cases an invitation to join the event by clicking a button, to the user on an “Events” page the user elects to open. In another embodiment, promotion of an event comprises displaying the event on the user's home page, e.g., in a dedicated “Events” section thereof. Events may be promoted in numerous other ways (e.g., via text, IM, email, etc.); however, each event will only be promoted to users for whom the event promotion feature has identified as “qualifying” to receive promotions for the event. Operation of the event promotion feature to identify “qualified” users for each event will be described in detail below. In general, a user will be deemed qualified to receive promotions for an event if the user meets certain criteria, or event parameters, designated for the event or with respect to other users who have already indicated that they will be attending the event, as will be described in detail below.

FIGS. 3-5 are flowcharts illustrating logic implemented by an event promotion feature in accordance with one embodiment. In one embodiment, the logic for implementing the event notification feature (potentially to be embodied in software) could be provided in web server 16. The logic illustrated in FIG. 3 may be implemented in response to a triggering event, such as a user's electing to view events or an automatic updating of an Events section of the user's home page, which may be performed periodically. The logic illustrated in FIG. 3 is performed in connection with determining whether a particular user is qualified to be notified of a particular event. As will be described with reference to FIG. 3, the logic may include scoring a variety of event-specific parameters with reference to the user. Event-specific parameter scoring may also include evaluating a user with respect to a group of users who have already indicated that they will be attending the particular event.

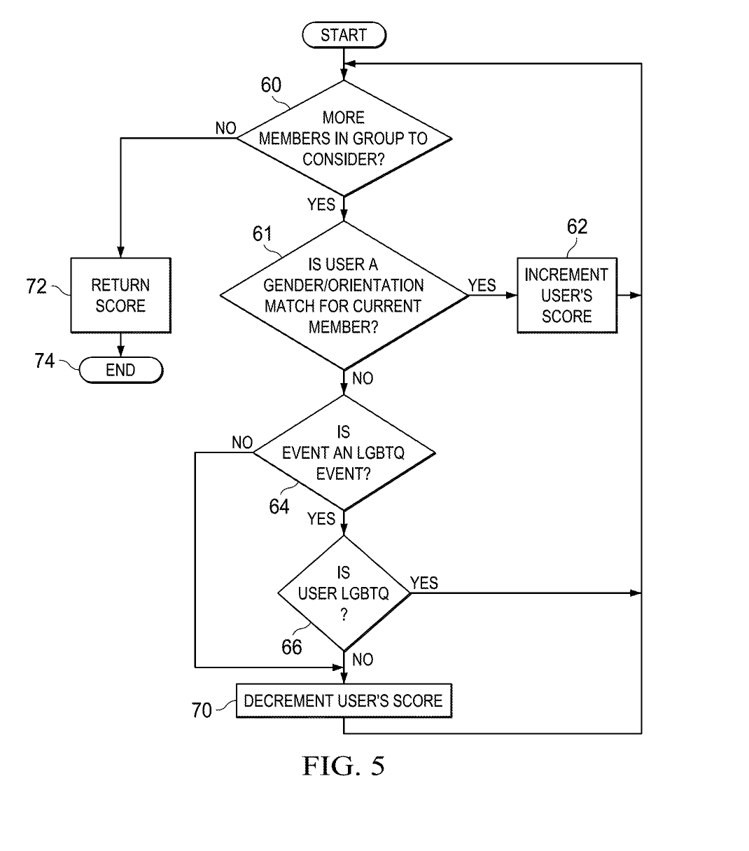

Referring to FIG. 3, in step 40, a determination is made whether there are more event parameters to score for the user. In one embodiment, parameters may include a targeted age, geographic location (zip codes, mileage ranges, urban vs. rural, etc.), a targeted gender, the type of activity involved in the event, any other demographic characteristic (income, previously divorced, religion, height/weight, education level, employment, how much a particular user has participated in such activities previously such that inexperience or experience could be used as a determinant, etc.) and a match quality (or match percentage) that characterizes how good of a match the user is relative to the event and/or relative to the other users who have already committed to participate in the event (“event participants”). If it is determined in step 40 that there are more event parameters that need to be scored for the user, execution proceeds to step 42, in which a score is computed for the current parameter. An example of how a particular score might be computed for a particular user/parameter pair is illustrated in and described in detail below with reference to FIG. 5. As mentioned above, a score for a parameter may be based on a target set for the event; for example, if a target age of an event is 25 and the user is 25, the score computed for the user for the age parameter will be a higher score than the score computed for the age parameter for a user who is 40. As another example, if a target gender/orientation of an event is gay males and the user is a straight male, the score assigned for the gender/orientation parameter will be lower than if the user is a gay male. In the same scenario, a bisexual male might receive a higher gender/orientation parameter score than the straight male but a lower one than a gay male. As also previously noted, whether the user would be a good “fit” with the group of current group participants may also be considered and scored.

Execution of steps 40 and 42 continue until a negative determination Is made at step 40, meaning that all of the event parameters have been scored. Execution then proceeds to step 44, in which a weighted average of all of the parameter scores is computed for the user relative to the event. For example, in certain cases (such as an event that is geared toward 20-30 year olds regardless of gender and orientation), age may be the most important consideration, so the age parameter score will be weighted more heavily in the weighted average score calculation than other parameters. In other cases, geographic location may be the most important factor and age less of a concern, in which case the geographic location parameter will be weighted more heavily in the weighted average score calculation than age. In step 36, the weighted average score is returned. It should be noted that, in some embodiments, a determination will need to be made whether certain information required for computing a score is available (e.g., age of the user, targeted age for the event) before the score will be computed. If the information is not available, the parameter is not scored or used in computing the weighted average score in step 44.

FIG. 4 illustrates another technique for determining whether to promote a particular event to a particular user. The technique illustrated in FIG. 4 utilizes filters, which may be used in addition to or instead of parameter scoring shown in FIG. 3, as a means for determining whether a particular event should be promoted to a particular user. Referring to FIG. 4, in step 50, a determination is made whether there are more filters to check. In one embodiment, filters may be related to the age of the user, the geographic location of the user, the gender of the user, a match quality of the user versus event participants, particular interests of the user, etc. In certain embodiments, there may be a corresponding filter for every parameter considered for the event, including the weighted average of the parameter scores. Returning to FIG. 4, if a positive determination is made in step 50, meaning not all of the filters have been applied for the event, in step 52, a score is computed for the parameter corresponding to the next filter that needs to be checked. Computation of scores in step 52 may be similar or identical to computation of scores in step 42 (FIG. 3). Once a parameter score has been computed in step 52, in step 54, the filter corresponding to the parameter score is applied. In some cases, the filter may be expressed as a range comprising a minimum score that should be met or exceeded or a maximum score that may not be exceeded. In other cases, the filter may be expressed as a range having an upper and lower bound between which the score should fall. In any event, if a determination is made in step 54 that the score “fails” after application of the filter, execution proceeds to step 56, in which the event is not shown to the user. However, if it is determined in step 54 that the score “passes” after application of the filter, execution returns to step 50. Once a negative determination is reached in step 50, indicating that the all of the filters have been applied and passed, in step 58, the event is shown to the user.

FIG. 5 is a flowchart illustrating a particular implementation of computing a score for a particular user/parameter pair with reference to a group of event participants using a gender balancing parameter as an example. For example, the steps shown in FIG. 5 may be embodied in step 42 of FIG. 3. As will be described, the steps illustrated in FIG. 5 are performed for each event participant (i.e., users who have already committed to participate in a particular event). Referring now to FIG. 5, in step 60, a determination is made whether there are more event participants members in the group to be considered. If a positive determination is made in step 60, execution proceeds to step 61, in which a determination is made whether the user is a gender/orientation match with the current participant. For example, if the current participant is a straight female and the user is a straight male, then a positive determination would be reached in step 61. Conversely, if the current participant is a gay male and the user is a straight male, then a negative determination would be reached in step 61.

If a positive determination is made in step 61, execution proceeds to step 62, in which the user's score (which is originally set to an initial value, such as zero) is incremented (e.g., by one) and execution returns to step 60. If a negative determination is made in step 61 execution proceeds to step 64, in which a determination is made whether the event is a lesbian/gay/bisexual/transsexual/questioning (“LGBTQ”) event. If it is determined in step 64 that the event is an LGBTQ event, execution proceeds to step 66. In step 66, a determination is made whether the user is LGBTQ. If it is determined in step 66 that the user is LGBTQ, execution returns to step 60. If it is determined in step 66 that the user is not LGBTQ, execution proceeds to step 70. In step 70, the user's score is decremented (e.g., by one) and execution then returns to step 60.

If it is determined in step 64 that the event is not an LGBTQ event, execution proceeds directly to step 70. Returning to step 60, if it is determined that there are no more event participants to consider, meaning the user has been scored relative to all event participants, execution proceeds to step 72. In step 72, the user's score is returned and in step 74, execution terminates.

The overall result of the logic illustrated in FIG. 5 is that the user's score is incremented for each event participant for whom s/he is a potential match based on gender/orientation and decremented for each event participant for which s/he is not a potential match based gender/orientation. An exception to the foregoing occurs in the case of LGBTQ events, in which case the score of a user who self-identifies as LGBTQ is not decremented for event participants for which s/he is not a potential match (e.g., the user is a gay male and the event participant is a bi or gay female or vice versa).

Although the present disclosure has been described in detail with reference to particular embodiments, it should be understood that various other changes, substitutions, and alterations may be made hereto without departing from the spirit and scope of the present disclosure. For example, although the present disclosure has been described with reference to a dating protocol, any service that deals with (or that leverages) profiles, photos, resumes, user information more generally, etc. could readily benefit from the present disclosure.

Moreover, although the present disclosure has been described with reference to a number of elements included within system 10, these elements may be rearranged or positioned in any appropriate manner to accommodate any suitable networking configurations. In addition, any of the elements of FIG. 1 may be provided as separate external components to system 10 or to each other where appropriate.

It should also be noted that any of the question portions of the platform can leverage any type of format. Thus, in any aspect of the online dating process described herein, such as establishing a personality profile, for example, any suitable question format can be employed. Example formats include a Yes/No format, a multiple choice question format, a short answer format, a true/false format, etc. Other formats can readily be used in order to achieve the desired responses and solicit the appropriate data.

Note that in certain example implementations, the matching functions outlined herein, such as those carried out by web server 16 and/or provided as an application for an endpoint being operated by an end user (e.g., a mobile application for an iPhone™), may be implemented by logic encoded in one or more non-transitory, tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory, as shown in FIG. 1, can store data used for the operations described herein. This includes the memory being able to store software, logic, code, or processor instructions that are executed to carry out the activities described in this Specification.

A processor can execute any type of instructions associated with the data to achieve the operations detailed herein in this Specification. In one example, the processor, as shown in FIG. 1, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

These devices illustrated herein may maintain information in any suitable memory (random access memory (“RAM”), ROM, EPROM, EEPROM, ASIC, etc.), software, hardware, or in any other suitable component, device, element, or object where appropriate and based on particular needs. Any of the memory items discussed herein should be construed as being encompassed within the broad term “memory.” Similarly, any of the potential processing elements, modules, and machines described in this Specification should be construed as being encompassed within the broad term “processor.” Each of the network elements can also include suitable interfaces for receiving, transmitting, and/or otherwise communicating data or information in a network environment.

Note that with the example provided above, as well as numerous other examples provided herein, interaction may be described in terms of more than one network element. However, this has been done for purposes of clarity and example only. In certain cases, it may be easier to describe one or more of the functionalities of a given set of flows by only referencing a limited number of network elements. It should be appreciated that system 10 (and its teachings) are readily scalable and can accommodate a large number of components, as well as more complicated/sophisticated arrangements and configurations. Accordingly, the examples provided should not limit the scope or inhibit the broad teachings of system 10 as potentially applied to a myriad of other architectures.

It is also important to note that the steps in the preceding flow diagrams illustrate only some of the possible signaling scenarios and patterns that may be executed by, or within, system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the present disclosure. Although the present disclosure has been described in detail with reference to particular arrangements and configurations, these example configurations and arrangements may be changed significantly without departing from the scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
determining a score for at least one parameter associated with an event and a user;
applying to the score a filter associated with the at least one parameter to determine whether the score falls within a range defined by the filter;
displaying the event to the user if the score falls within the range defined by the filter; and
hiding the event from the user if the score falls outside of the range defined by the filter.

2. The method of claim 1, wherein the determining a score comprises:
assigning an initial value to the score;
incrementing the score for each participant in the event with whom the user is a potential match based on a first set of criteria; and
decrementing the score for each participant in the event with whom user is not a potential match based on the first set of criteria.

3. The method of claim 1, wherein the displaying comprises presenting information regarding the event on a web page accessible by the user.

4. The method of claim 3, wherein the information includes an invitation to participate in the event.

5. The method of claim 1, wherein the at least one parameter comprises one of a targeted age for participants in the event, a targeted gender/orientation for participants in the event, a geographic location, and a match quality quantifying how closely matched the user is with participants in the event.

6. The method of claim 1, wherein the at least one parameter comprises a plurality of parameters and each of the parameters has associated therewith a filter defining a range, the method further comprising, for each of the parameters:
determining a score for the parameter;
applying to the score the filter associated with the parameter to determine whether the score falls within the range defined by the filter and thereby passes application of the filter.

7. The method of claim 6 further comprising:
displaying the event to the user if all of the scores pass application of the respective filters; and
hiding the event from the user if one of the scores fails to pass application of the respective filter.

8. The method of claim 6, further comprising:
computing a weighted average of the parameter scores; and
applying a filter to the weighted average of the parameter scores.

9. One or more non-transitory tangible media that includes code for execution and when executed by a processor is operable to perform operations comprising:
determining a score for at least one parameter associated with an event and a user;
applying to the score a filter associated with the at least one parameter to determine whether the score falls within a range defined by the filter;
displaying the event to the user if the score falls within the range defined by the filter; and
hiding the event from the user if the score falls outside of the range defined by the filter.

10. The media of claim 9, wherein the determining a score comprises:
assigning an initial value to the score;
incrementing the score for each participant in the event with whom the user is a potential match based on a first set of criteria; and
decrementing the score for each participant in the event with whom user is not a potential match based on the first set of criteria.

11. The media of claim 9, wherein the displaying comprises presenting information regarding the event on a web page accessible by the user, the information including an invitation to participate in the event.

12. The media of claim 9, wherein the at least one parameter comprises one of a targeted age for participants in the event, a targeted gender/orientation for participants in the event, a geographic location, and a match quality quantifying how closely matched the user is with participants in the event.

13. The media of claim 9, wherein the at least one parameter comprises a plurality of parameters and each of the parameters has associated therewith a filter defining a range, the media further including code for execution and when executed by a processor is operable to perform operations comprising, for each of the parameters:
determining a score for the parameter;
applying to the score the filter associated with the parameter to determine whether the score falls within the range defined by the filter and thereby passes application of the filter.

14. The media of claim 13, wherein the media further includes code for execution and when executed by a processor is operable to perform operations comprising:
displaying the event to the user if all of the scores pass application of the respective filters; and
hiding the event from the user if one of the scores fails to pass application of the respective filter.

15. The media of claim 13, wherein the media further includes code for execution and when executed by a processor is operable to perform operations comprising:
computing a weighted average of the parameter scores; and
applying a filter to the weighted average of the parameter scores.

16. A server, comprising:
a processor and a memory, wherein the server is configured to:
determine a score for at least one parameter associated with an event and a user;
apply to the score a filter associated with the at least one parameter to determine whether the score falls within a range defined by the filter;
display the event to the user if the score falls within the range defined by the filter; and
hide the event from the user if the score falls outside of the range defined by the filter.

17. The server of claim 16 further configured to:
assign an initial value to the score;
increment the score for each participant in the event with whom the user is a potential match based on a first set of criteria; and
decrement the score for each participant in the event with whom user is not a potential match based on the first set of criteria.

18. The server of claim 16, wherein the displaying comprises presenting information regarding the event on a web page accessible by the user.

19. The server of claim 16, wherein the at least one parameter comprises one of a targeted age for participants in the event, a targeted gender/orientation for participants in the event, a geographic location, and a match quality quantifying how closely matched the user is with participants in the event.

20. The server of claim 16, wherein the at least one parameter comprises a plurality of parameters and each of the parameters has associated therewith a filter defining a range, and wherein the server is further configured to:
for each of the parameters:
determine a score for the parameter;
apply to the score the filter associated with the parameter to determine whether the score falls within the range defined by the filter and thereby passes application of the filter;
display the event to the user if all of the scores pass application of the respective filters; and
hide the event from the user if one of the scores fails to pass application of the respective filter.
